(19) United States
(12) Patent Application Publication
(10) Pub. No.: US 2017/0022002 A1
(43) Pub. Date: Jan. 26, 2017

(54) Disposable Auto/Car Garbage Bags

(71) Applicant: Koko Masako Sandmeyer, Los Angeles, CA (US)

(72) Inventor: Koko Masako Sandmeyer, Los Angeles, CA (US)

(21) Appl. No.: 14/804,877

(22) Filed: Jul. 21, 2015

(51) Int. Cl. B65F 1/00

(52) U.S. Cl. CPC B65F 1/0013; B65F 1/0026

(57) ABSTRACT

This permanent pliable wire-like addition to the basic disposable car garbage bag enables the garbage bag to be attached, secured and/or wrapped around anywhere in your car so your garbage doesn't have to be just in the front middle area of the car and other people in places like the back seat can have access to a garbage bag and it can be used, if scented, as an air freshener. The ancient disposable car garbage only fit around your automatic or manual gear shift and that created problems or hindered movement of the gear shift and to some people not very aesthetically pleasing to have a disposable garbage bag, solely, in that particular area.

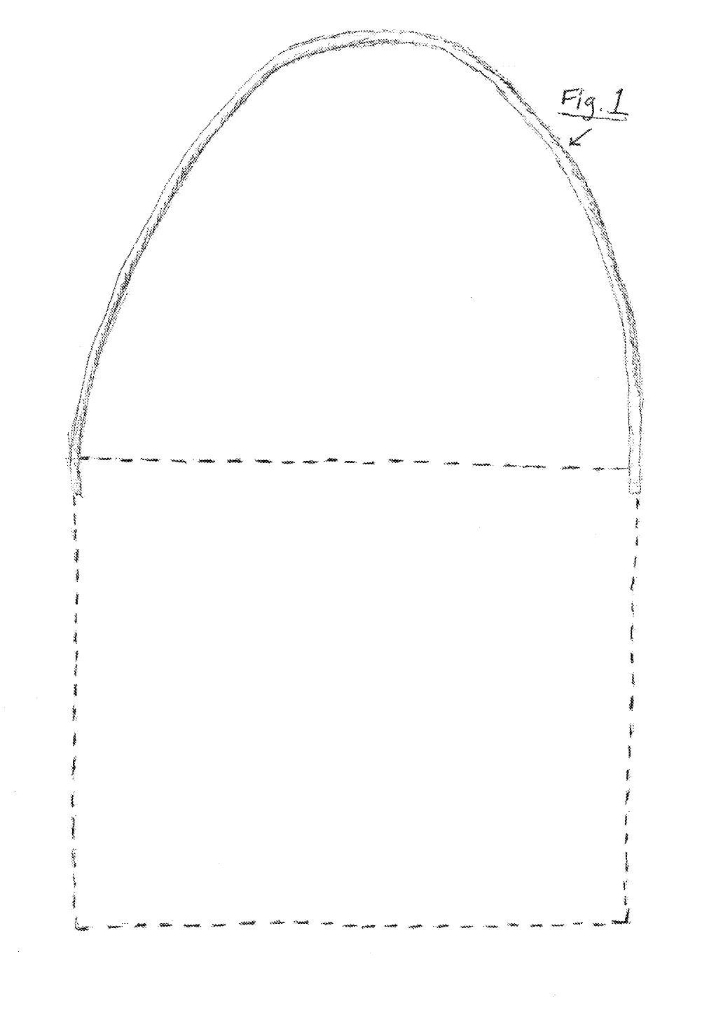

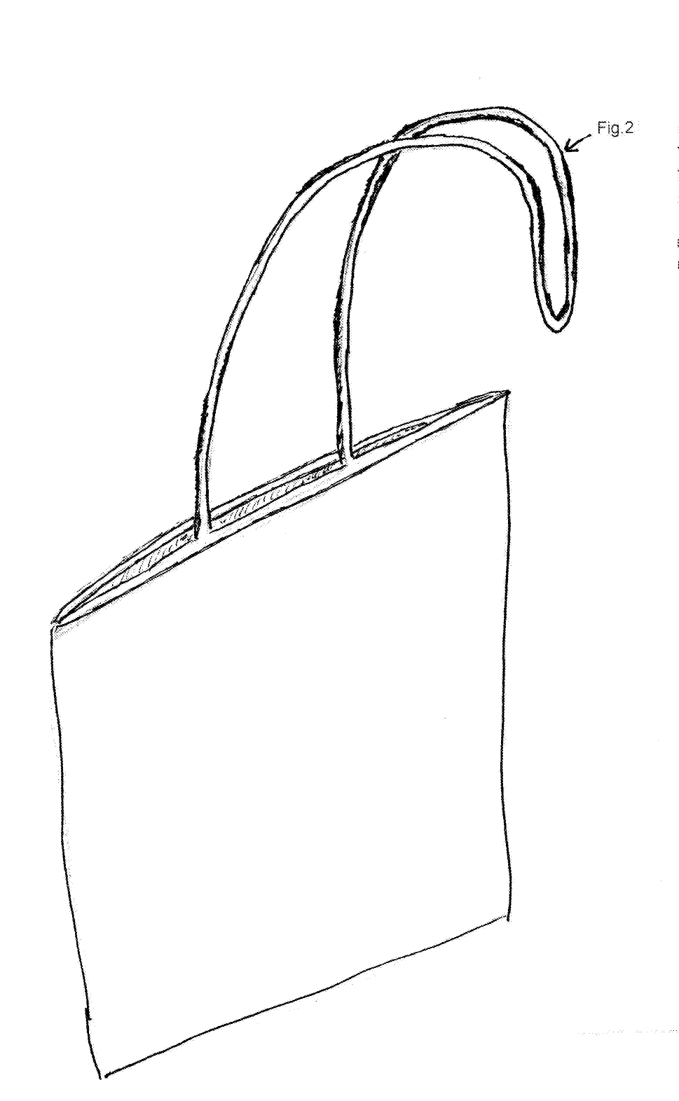

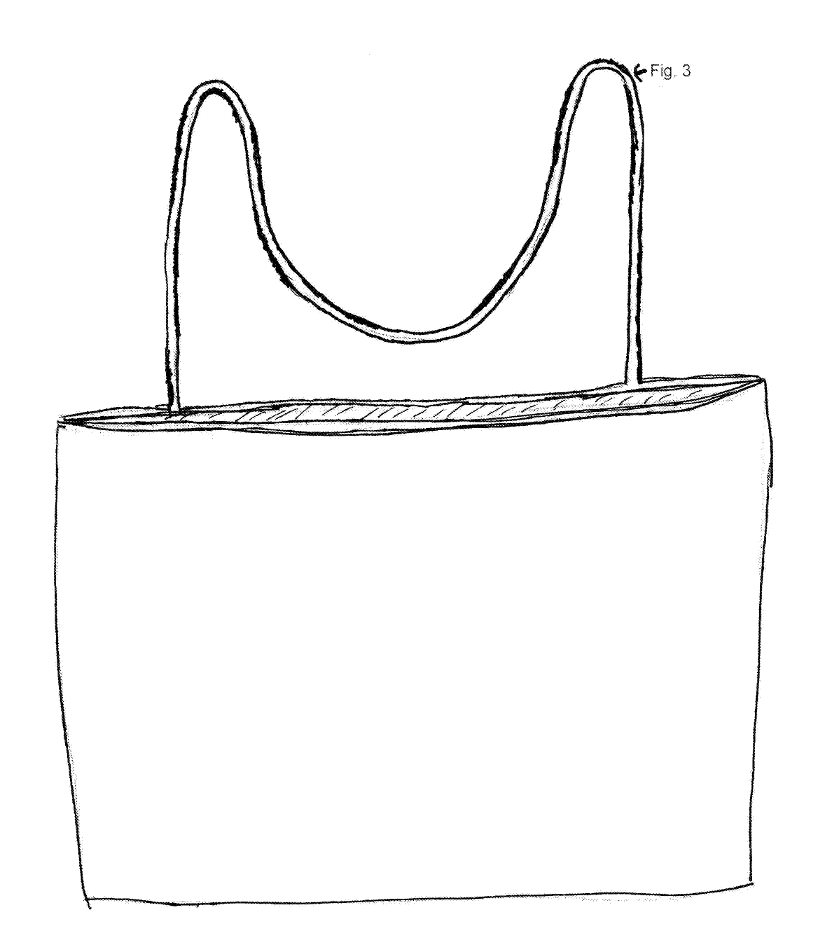

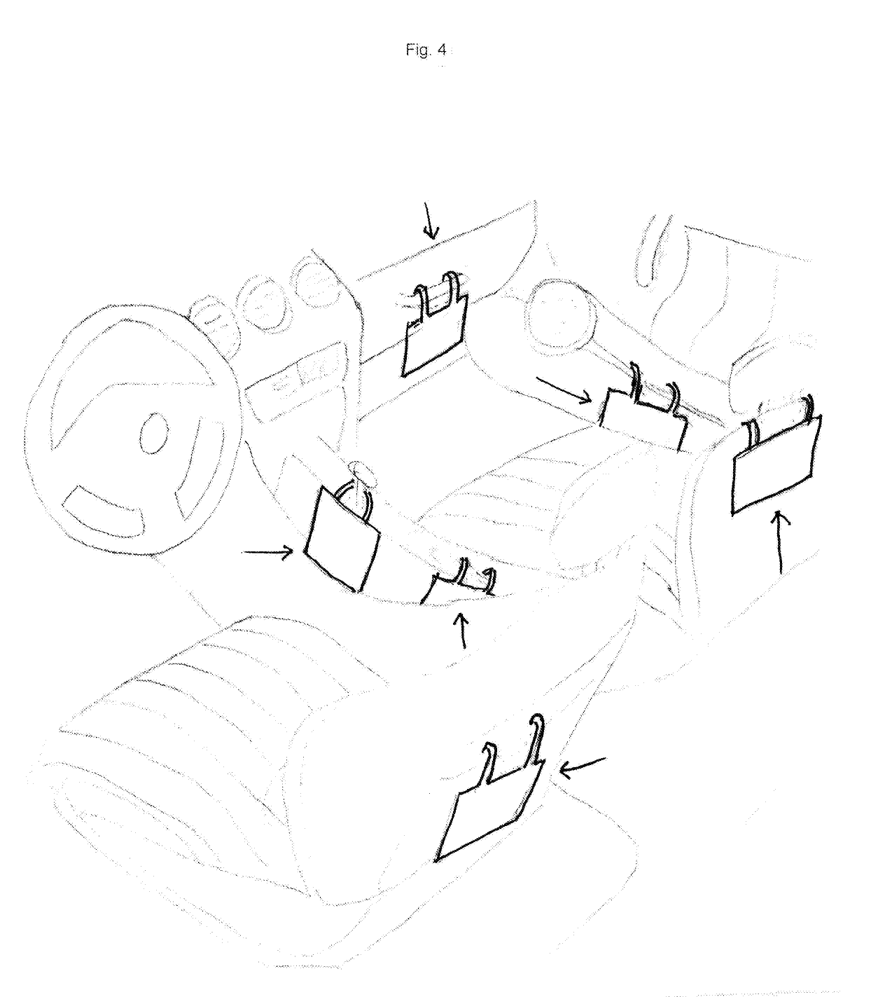

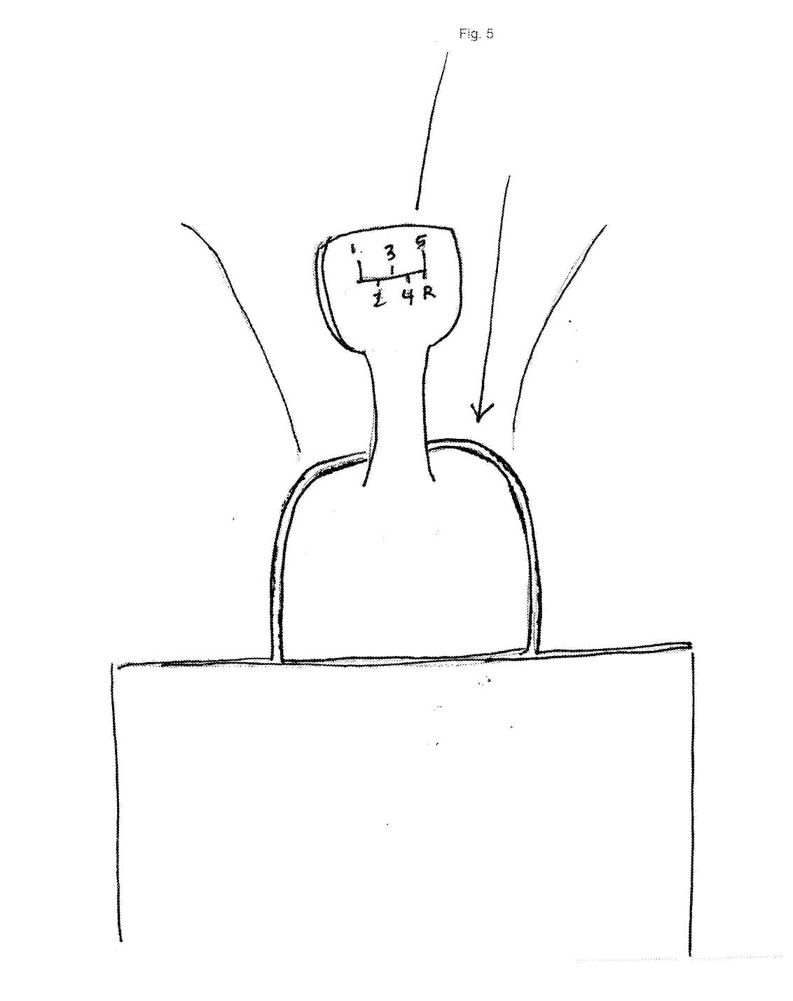

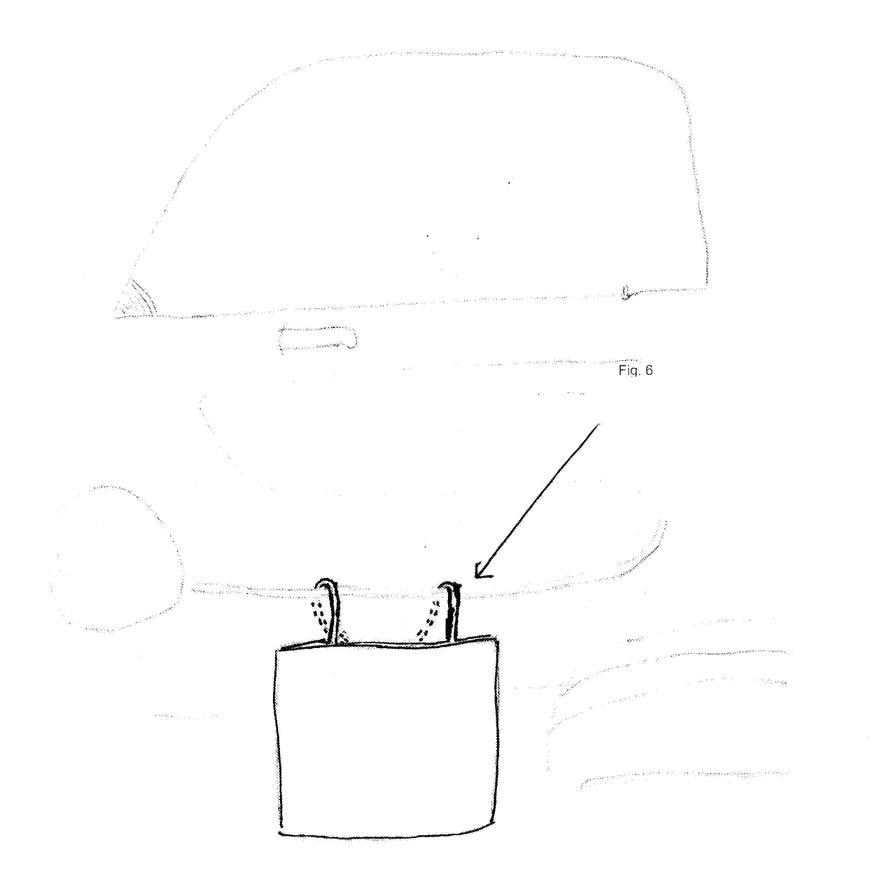

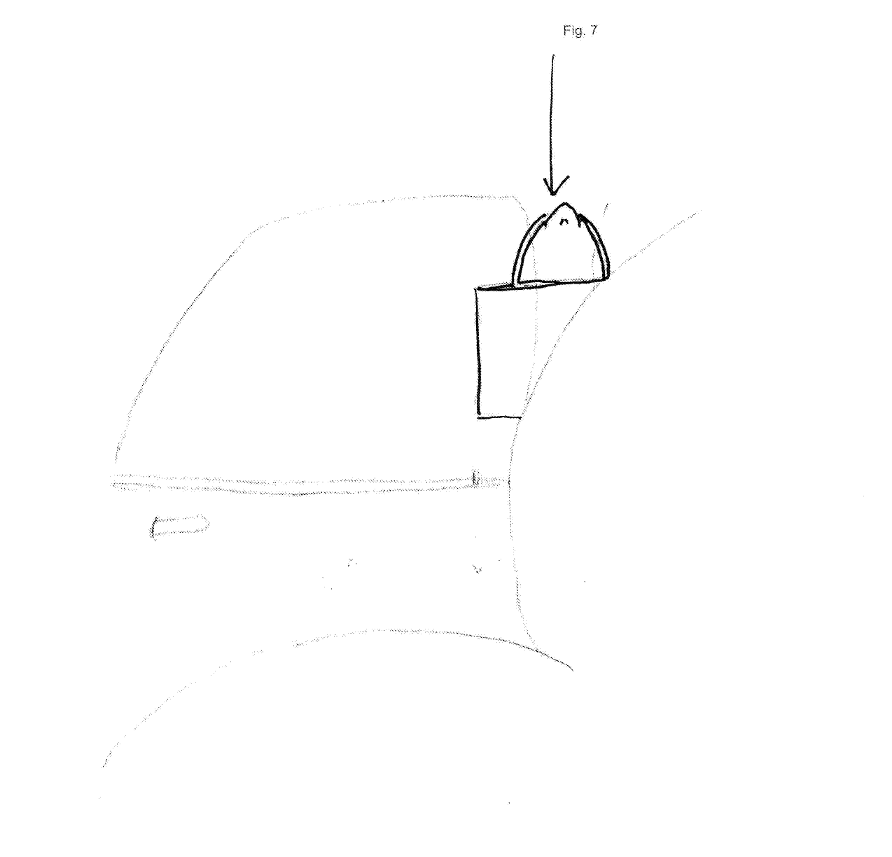

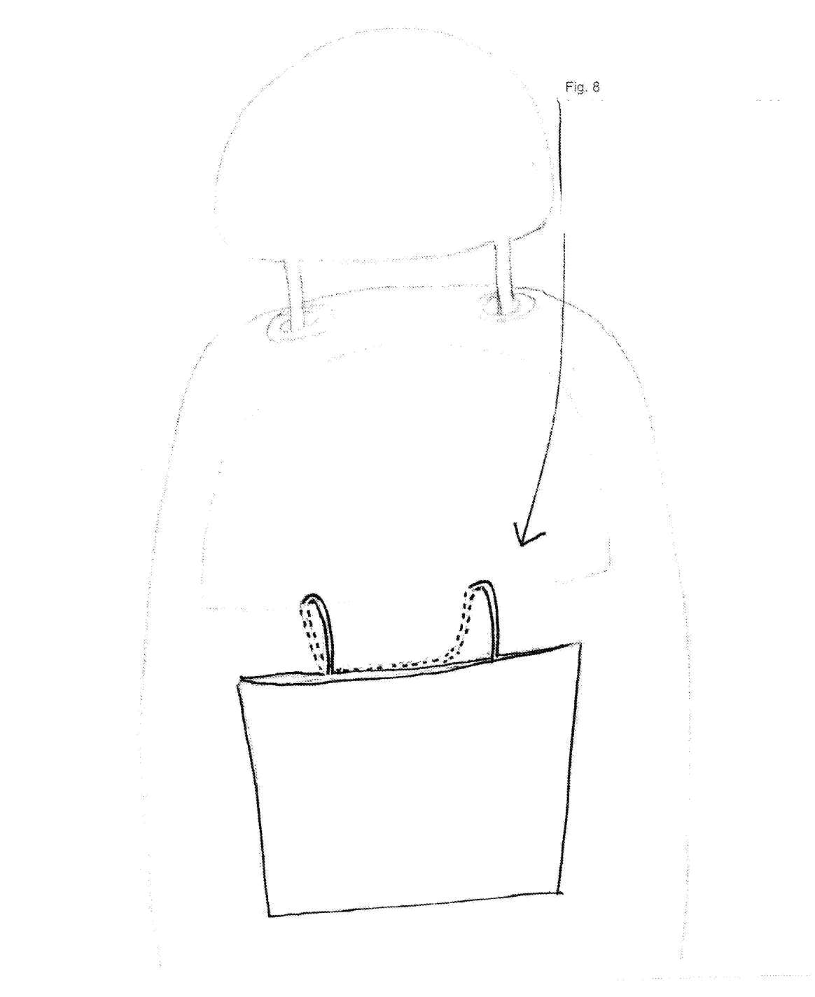

I have invented a new design for a Disposable Auto/Car Garbage Bag as set forth in the following specification:

This permanent pliable wire-like attachment to the disposable car garbage bag enables you to manipulate and maneuver it to attach or secure to any part of your car. It can be scented or unscented. If scented, it acts as a car air freshener as well.

### BACKGROUND OF THE INVENTION

This invention transpired during a time where I valet parked cars and in all of the cars there were no garbage bags and there were things from orange peels to gum wrappers on the floor in the front and back seat. Some people would use the plastic bags from the grocery store but after they were banned, that really made me realize the need for my invention. In the past there were disposable car garbage bags that you would sometimes receive when you rented a car but it was just a bag with a hole in it that only fit over the front stick. So I realized the problem and thought of a way where a car disposable garbage bag can be utilized in every part of your car and can be scented or non-scented.

### BRIEF SUMMARY OF INVENTION

This new and improved disposable car garbage bag can be utilized by everyone that drives a car. It will enable there to be anywhere in your car a disposable car garbage bags. In the past there were disposable car garbage bags but they were only able to be affixed around the front stick of your car. They have pretty much become extinct due to this limitation because people don't want anything hindering the functioning of their driving device, i.e. the manual or automatic stick if it is hanging on it. Also, not everyone wants their garbage to be on display in front and also want the back seat passengers to dispose of their garbage conveniently and discreetly.

### DETAILED DESCRIPTION OF THE INVENTION

A pliable wire like attachment, scented or unscented, permanently attached to a disposable car garbage bag wherein the attachment can be manipulated and/or maneuvered to fit anywhere in your car. You can put it over the front stick, bend it to fit into the side pocket of your car door, the back passenger pocket on the backside of the front seats or any where you can manipulate it to wrap around or attach to any apparatus in your car. Different types of bags can be used from plastic to biodegradable. And the permanent attachment, if scented can also be utilized as a car air freshener.

1. A pliable wire-like permanent attachment to the disposable car garbage bag that enables you to manipulate and maneuver it to attach/secure to any part your car.

2. A pliable wire-like permanent attachment to the disposable car garbage bag that if scented is capable of use as an air freshener.
